(19) United States
(12) Patent Application Publication
(10) Pub. No.: US 2019/0132043 A1
(43) Pub. Date: May 2, 2019

(54) WIRELESS SIGNAL ENHANCEMENT DEVICE, METHOD, SYSTEM, AND STORAGE MEDIUM

(71) Applicant: ZMODO TECHNOLOGY SHENZHEN CORP. LTD., Shenzhen (CN)

(72) Inventors: Kevinkelin Wan, Shenzhen (CN); Songwei Wang, Shenzhen (CN); Jianping Li, Shenzhen (CN); Jinzhu Pan, Shenzhen (CN)

(21) Appl. No.: 15/743,147

(22) PCT Filed: Oct. 31, 2017
(86) PCT No.: PCT/CN2017/108673

§ 371 Date: Jan. 9, 2018

(51) Int. Cl. H04B 7/155; H04B 17/40; H04L 12/66; H04B 17/12; H04B 17/318; H04B 17/382

(52) U.S. Cl. CPC H04B 7/15535; H04B 17/402; H04B 17/382; H04B 17/12; H04B 17/318; H04L 12/66

(57) ABSTRACT

The present disclosure provides a wireless signal enhancement device. The wireless signal enhancement device includes: at least two wireless communication modules of different types used to receive corresponding wireless signal and transmit the wireless signal to a first processor; and the first processor coupled to the wireless communication module and used to receive and parse the wireless signal transmitted by the wireless communication module to obtain a parsing result; the wireless communication module receiving the wireless signal is further used to enhance the wireless signal.

### FIELD OF THE INVENTION

The present disclosure relates to a field of communication technology, and more particularly relates to a wireless signal enhancement device, a method, a system, and a storage medium.

### BACKGROUND OF THE INVENTION

With the rapid development of society, wireless communication is used in more and more occasions. For example, wireless fidelity (WIFI) technology, 433/868/915 MHz wireless communication technology, and Z-WAVE technology (a short range wireless communication technology which is based on radio frequency, having low cost, low power consumption, and high-reliability, and being suitable for a network) are applied to the wireless communication in a smart home. Using these technologies, wireless signals are affected by many factors in the transmission process, and the wireless signals will be weakened or even disappear. For example, when WIFI signal is in an occasion where the equipment layout of the environment is relatively wide and there are many obstacles (such as walls) required to penetrate, the WIFI signal may be weakened and a transmission speed becomes slow. For the Z-WAVE technology, when a transmission distance of node data is far, the signal will be weakened or even disappear. The 433/868/915 MHz wireless communication has some deficiencies, as well. When multiple wireless devices transmit data at the same time, the phenomenon of a receiving terminal missing receiving data packets may occur.

In general, a conventional wireless signal enhancement device only enhances the WIFI signal, or one type of wireless signal, which cannot meet people's demand.

### SUMMARY OF THE INVENTION

According to various embodiments, a wireless signal enhancement device, a method, a system, and a storage medium are provided.

A wireless signal enhancement device includes:

at least two wireless communication modules of different types used to receive corresponding wireless signal and transmit the wireless signal to a first processor;

the first processor coupled to the wireless communication module and used to receive and parse the wireless signal transmitted by the wireless communication module to obtain a parsing result;

the wireless communication module receiving the wireless signal is further used to enhance the wireless signal.

A wireless signal enhancement method includes:

receiving, by at least two wireless communication modules of different types, corresponding wireless signal;

parsing the wireless signal received by the wireless communication modules to obtain a parsing result; and

enhancing, by the wireless communication modules, the wireless signal.

A wireless signal enhancement system includes:

at least two wireless communication modules of different types used to receive corresponding wireless signal and transmit the wireless signal to a first processor;

the first processor coupled to the wireless communication module and used to receive and parse the wireless signal transmitted by the wireless communication module to obtain a parsing result;

the wireless communication module receiving the wireless signal is further used to enhance the wireless signal; and

a mobile device coupled to the first processor and used to receive the parsing result obtained by parsing the wireless signal by the first processor.

At least one non-transitory computer-readable medium comprising computer executable instructions, which, when executed by at least one processor cause the at least one processor to perform steps including:

receiving, by at least two wireless communication modules of different types, corresponding wireless signal;

parsing the wireless signal received by the wireless communication modules to obtain a parsing result; and

enhancing, by the wireless communication modules, the wireless signal.

The details of one or more embodiments of the present disclosure will be presented with reference to the following drawings and description. Other characteristics, purposes and advantages of the present disclosure will be more apparent from the specification, drawing and claims.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a block diagram of a wireless signal enhancement device according to an embodiment;

FIG. 2 is a block diagram of a wireless signal enhancement device according to another embodiment;

FIG. 3 is an application block diagram of a wireless signal enhancement device according to an embodiment;

FIG. 4 is an application environment of a wireless signal enhancement device according to an embodiment;

FIG. 5 is a flowchart of a wireless signal enhancement method according to an embodiment; and

FIG. 6 is a block diagram of a wireless signal enhancement system according to an embodiment.

### DETAILED DESCRIPTION OF THE EMBODIMENTS

The present disclosure will be described in details with reference to the accompanying drawings and embodiments such that the purpose, technical solution and advantages of the present disclosure will be more apparent. The various embodiments of the invention may, however, be embodied in many different forms and should not be construed as limited to the embodiments set forth herein. Rather, these embodiments are provided so that this disclosure will be thorough and complete, and will fully convey the scope of the present disclosure to those skilled in the art.

The present disclosure will be described in details with reference to the accompanying drawings and embodiments such that the purpose, technical solution and advantages of the present disclosure will be more apparent. The various embodiments of the invention may, however, be embodied in many different forms and should not be construed as limited to the embodiments set forth herein. Rather, these embodiments are provided so that this disclosure will be thorough and complete, and will fully convey the scope of the present disclosure to those skilled in the art.

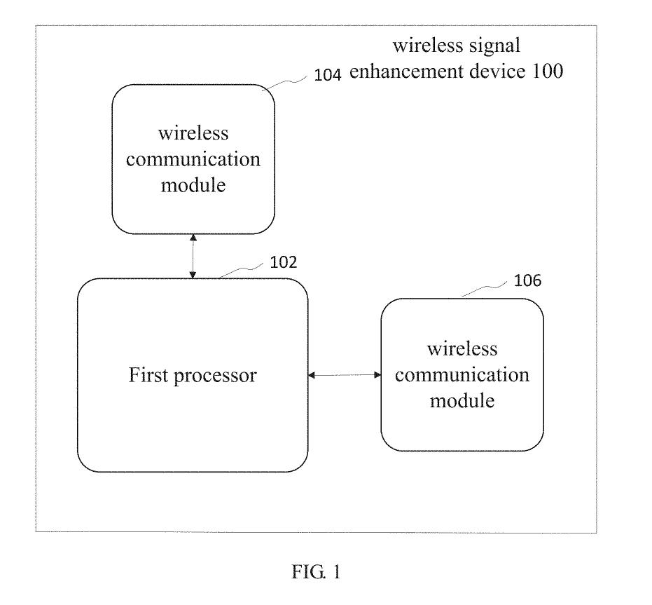

Referring to FIG. 1, according to an embodiment, a wireless signal enhancement device 100 includes a first processor 102, and at least two wireless communication modules 104, 106, which are of different types.

The wireless communication module 104 and the wireless communication module 106 are used to receive corresponding wireless signal and transmit the wireless signal to the first processor 102.

The first processor 102 is coupled to the wireless communication module 104 and the wireless communication module 106, respectively. The first processor 102 is used to receive the wireless signal transmitted by the wireless communication module 104 or the wireless communication module 106.

The wireless communication module 104 or the wireless communication module 106 is further used to enhance the wireless signal.

In one of the wireless communication modules 104, the wireless communication module 104 can enhance the received wireless signal directly. The wireless communication module 104 receives the wireless signal using the same band and the same protocol via a modulation-demodulation method, and transmits the wireless signal to the first processor 102. The first processor 102 receives and parses the wireless signal to obtain a parsing result, which may be an identification of a transmitting device, an identification of a target device, or specific content, etc. The wireless communication module 104 directly enhances the received wireless signal via the modulation-demodulation method.

In another wireless communication module 106, when the wireless signal is about to be enhanced, the wireless communication module 106 must perform an enhancement process on the wireless signal according to the parsing result obtained by parsing the wireless signal via the first processor 102. The wireless communication module 106 receives the wireless signal using the same band and the same protocol via the modulation-demodulation method, and transmits the wireless signal to the first processor 102. The first processor 102 receives and parses the wireless signal to obtain the parsing result, and transmits the parsing result to the wireless communication module 106. The wireless communication module 106 enhances the wireless signal according to the parsing result.

According to the aforementioned embodiment, multiple wireless communication modules receive different wireless signals, and the wireless signals are parsed in the first processor, and then the received wireless signals are enhanced in the corresponding wireless communication modules, such that the device for receiving the wireless signal can receive the wireless signal more easily, so as to achieve enhancement of multiple wireless signals.

Referring to FIG. 2, according to an embodiment, a wireless signal enhancement device 200 includes a first processor 202, a wireless fidelity (WIFI) module 204, a Z-WAVE module 206, and a 433/868/915 MHz transceiver module 208.

The WIFI module 204 is coupled to the first processor 202 and is set as a wireless relay mode. The WIFI module 204 is used to relay and amplify the received wireless signal and then transmit the received wireless signal via the modulation-demodulation method.

Specifically, the WIFI module 204 is coupled to the first processor 202 via a communication interface. The communication interface can be a universal serial bus (USB) interface, a secure digital input and output card (SDIO) interface, or an inter-integrated circuit (IIC) interface. The WIFI module 204 is set as a wireless relay mode, which takes advantage of a function of wireless relay of a wireless access point (AP) to relay the wireless signal from one relay point to a next relay point to form a new wireless coverage area. Therefore the relay mode of multiple wireless relay coverage points is formed, thereby achieving the purpose of extending the coverage range of the wireless network. The WIFI module 204 is equivalent to the relay point, which can relay and amplify the received wireless signal and then transmit the received wireless signal via the modulation-demodulation method to form wireless signal coverage.

The Z-WAVE module 206 is coupled to the first processor 202. The Z-WAVE module 206 is set as a control device and is used to receive a node identification of a target Z-WAVE device obtained by parsing the wireless signal via the first processor 202, and to transmit the received wireless signal to the target Z-WAVE device via a modulation-demodulation method according to the node identification.

Specifically, the Z-WAVE module 206 is coupled to the first processor 202 via the communication interface. The communication interface can be the USB interface, the SDIO interface, or the IIC interface. The Z-WAVE module 206 can receive and transmit a wireless signal of a Z-WAVE protocol via a frequency-shift keying (FSK) modulation-demodulation method. The Z-WAVE module 206 is set as a control device. Specifically, there are two fundamental types of devices in the Z-WAVE protocol, a controller device and a slave device. The controller device can transmit a control instruction to other nodes, and the slave device can respond to the corresponding control instruction. The Z-WAVE module 206 receives the node identification of the target Z-WAVE device obtained by parsing the wireless signal via the first processor 202, and transmits the received Z-WAVE wireless signal to the target Z-WAVE device via the FSK modulation-demodulation method according to the node identification.

According to an embodiment, if the target Z-WAVE device is not within a transmission range of the Z-WAVE module, the Z-WAVE module will search routing information of reaching the target device in its own routing table. The Z-WAVE module transmits the wireless signal to a Z-WAVE device adjacent to the target Z-WAVE device according to the routing information. The adjacent Z-WAVE device receives the wireless signal and parses the node identification of the target Z-WAVE device, and then transmits the wireless signal to the target Z-WAVE device according to the node identification of the target Z-WAVE device, so as to achieve a communication between two Z-WAVE devices which are not within the wireless communication distance, thereby extending the wireless communication distance of the Z-WAVE device.

The 433/868/915 MHz transceiver module 208 is coupled to the first processor 202. The 433/868/915 MHz transceiver module 208 is set as a receiving mode to monitor and receive a wireless signal of 433/868/915 MHz band. The 433/868/915 MHz transceiver module is used to transmit the wireless signal to the first processor 202 and determine the number of times of forwarding the wireless signal according to an identification of a transmitting device and information content obtained after the first processor parses the wireless signal using a customized communication protocol. The 433/868/915 MHz transceiver module 208 is used to forward the wireless signal according to the number of times of forwarding the wireless signal.

Specifically, the 433/868/915 MHz transceiver module 208 is coupled to the first processor 202 via the communication interface. The communication interface may be the USB interface, the SDIO interface, or the IIC interface. The 433/868/915 MHz transceiver module 208 is set as the receiving mode and permanently receives the 433/868/915 MHz band and monitors the wireless signal of the 433/868/915 MHz band. A monitoring band of the 433/868/915 MHz transceiver module 208 should be the same as a receiving band of the 433/868/915 MHz communication device requiring to forward signal. The 433/868/915 MHz transceiver module 208 communicates with the 433/868/915 MHz communication device requiring to forward signal using the same communication protocol, i.e., a customized communication protocol. The 433/868/915 MHz transceiver module 208 receives the wireless signal and transmits the wireless signal to the first processor 202. The first processor 202 parses the wireless signal according to the customized communication protocol to obtain the identification of the transmitting device and the information content, so as to determine the number of times of forwarding the wireless signal. Such that the first processor 202 forwards the wireless signal according to the number of times of forwarding the wireless signal, and performs different processes to the different devices and the different information contents. For example, the process is performed according to an importance of the information content. If the information contents are only data content regularly reported by the transmitting terminal, for example, data information such as temperature and humidity which is forwarded only once; as for warning information such as a smoke sensor and a combustible gas sensor, which should be forwarded multiple times, usually three to five times, so as to ensure that the data package of the content will not be lost.

According to the aforementioned embodiments, the WIFI module in the device enhances the WIFI signal, the Z-WAVE module enhances the corresponding wireless signal, and the 433/868/915 MHz transceiver module enhances the corresponding wireless signal, which are independent to each other, each of which enhance different wireless signals. Therefore the device for receiving the wireless signal can receive the wireless signal more easily, so as to achieve enhancement of multiple wireless signals.

According to an embodiment, the wireless communication module is further used to detect signal strength of the received wireless signal and determine a wireless signal strength level of a current wireless signal area according to the signal strength of the wireless signal, and transmit the wireless signal strength level of the wireless signal area to the first processor.

Specifically, the WIFI module, the Z-MAVE module, and the 433/868/915 MHz transceiver module have a function of detecting the signal strength of the received wireless signal, and determining the wireless signal strength level of the current wireless signal area according to the signal strength of the wireless signal, and then transmitting the wireless signal strength level of the wireless signal area to the first processor.

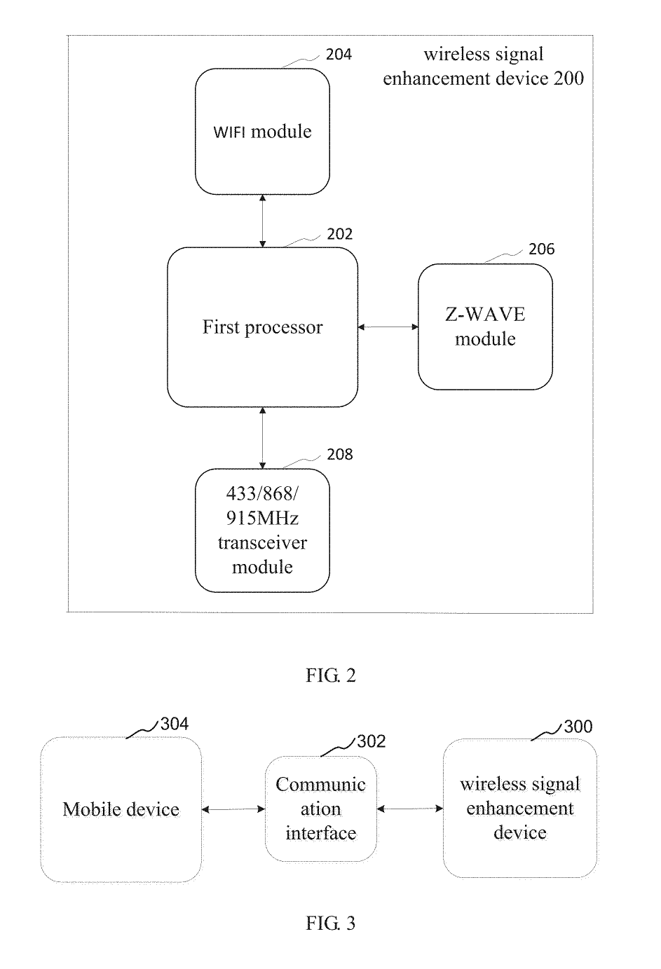

Referring to FIG. 3, according to an embodiment, FIG. 3 is an application block diagram of a wireless signal enhancement device, which includes a wireless signal enhancement device 300, a communication interface 302, and a mobile device 304.

Specifically, the mobile device can be a mobile robot, an unmanned aerial vehicle (UAV) and the like that can move and be equipped with a wireless signal enhancement device.

The mobile device 304 carries the wireless signal enhancement device 300 via the communication interface 302. The communication interface 302 is coupled to a first processor of the wireless signal enhancement device 300, and is further coupled to the mobile device to transmit data of the first processor to the mobile device 304, such that the mobile device 304 can perform data exchange with the first processor via the communication interface.

Specifically, the communication interface 302 can be a USB interface, a SDIO interface, or an IIC interface. The first processor parses the received wireless signal to obtain a parsing result. The first processor transmits the parsing result to the mobile device 304 via the communication interface. The mobile device 304 moves according to the parsing result, and moves differently according to the different parsing results. If alarm information is parsed, the information is promptly transmitted to a receiving terminal, and the mobile device can move to a device transmitting the alarm information. The information of the alarm device can be recorded, if there is a camera mounting on the mobile device.

According to an embodiment, the first processor can further receive data of wireless signal strength level, and transmit the data of the wireless signal strength level to the mobile device 304 via the communication interface. The mobile device 304 receives the data of the wireless signal strength level, and moves according to the wireless signal strength level.

According to an embodiment, the communication interface is also coupled to a power supply of the mobile device to power the wireless signal enhancement device 300.

According to the aforementioned embodiment, the wireless signal enhancement device is equipped on the mobile device via the communication interface. By the mobile device performing data exchange with the first processor of the wireless signal enhancement via the communication interface, the mobile device can be controlled to move according to the parsing result of the first processor. The wireless signal enhancement device can also control the mobile device to move to enhance the wireless signal of different areas, therefore the problem of interruption when the receiving device receives the wireless signal due to the level difference of wireless signal strength in a region is solved.

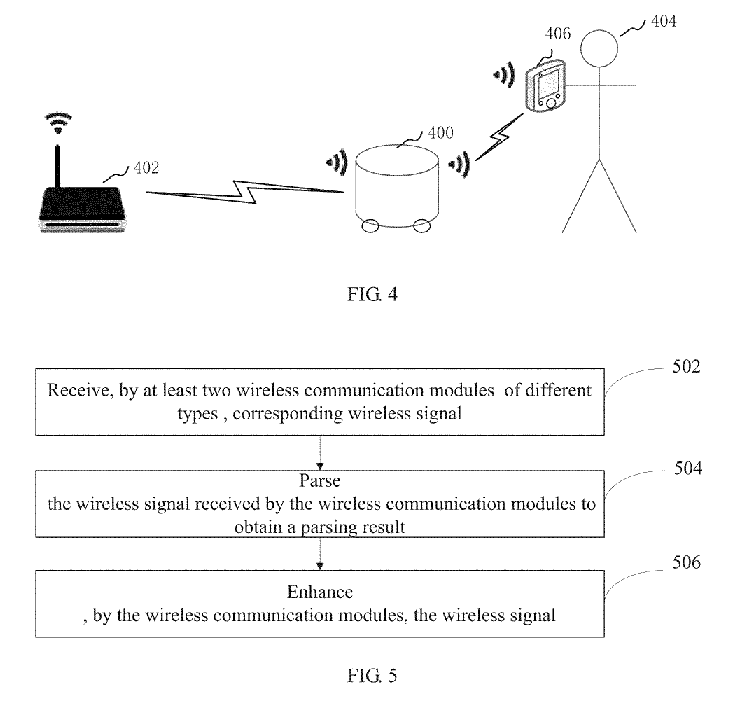

Referring to FIG. 4, FIG. 4 is an application environment of a wireless signal enhancement device according to an embodiment, specifically, in an indoor environment. The wireless signal enhancement device includes a wireless router 402, a mobile robot 400 equipped with the wireless signal enhancement device, a user 404, and a mobile phone 406. The mobile robot 400 is equipped with the wireless signal enhancement device. The WIFI module in the wireless signal enhancement device receives the wireless signal transmitted by the wireless router 402, and relays and amplifies the wireless signal in a wireless relay mode, and then transmits the wireless signal via the modulation-demodulation method. When the user 404 uses the mobile phone 406, the mobile robot can follow the user 404 and enhance the wireless signal around the user 404 via the wireless signal enhancement device. Therefore when the user 404 is using the cell phone 406, the wireless signal can be received regardless of the place in the home, and the problem that the wireless signal is weaken or interrupted will not happen, thereby facilitating the user 404 to use the mobile phone 406.

In the illustrated embodiment, the Z-WAVE module in the wireless signal enhancement device equipped on the mobile robot 400 can further receive alarm information of door sensor, and transmits it to the receiving device and the first processor. The first processor receives the alarm information, and then parses the alarm information to obtain a location where the door sensor is triggered, and transmits the location to the mobile device via the communication interface. The mobile device can move to the location to check the situation. If a camera is mounted on the mobile device, the situation where the door is triggered can be recorded by the camera. When no one is at home, what happened at home can be known, thereby ensuring home safety.

According to an embodiment, the wireless signal enhancement device can also be equipped on the UAV, which enables achieving signal retrieval and enhancement of a greater range. For example, in some disaster scenarios, someone calls for help using emergency rescue equipment of 915 MHz, the 433/868/915 MHz transceiver module of the wireless signal enhancement device in the UAV receives the SOS signal of 915 MHz and parses the wireless signal to obtain the identification of the transmitting device, and then forwards the wireless signal to rescuers at three to five times. The rescuers can locate the area where help-seekers are located according to the received wireless signal, thereby improving the efficiency of searching and rescuing.

According to the aforementioned embodiments, the wireless signal enhancement device and the mobile device cooperate to achieve different functions in different scenarios, such that the problem that the conventional wireless signal enhancement device can only enhance a single wireless signal in a fixed location can be solved, which makes applications of the wireless signal enhancement device more extensive and flexible.

Referring to FIG. 5, according to an embodiment, a wireless signal enhancement method is provided, which includes:

In step S502, a corresponding wireless signal is received by at least two wireless communication modules of different types.

Specifically, according to different wireless signals, the corresponding wireless communication module is used to receive the wireless signals. Two wireless communication modules can at least receive two different wireless signals. The wireless signals have the same band and communication protocol. The received wireless signals are transmitted to the first processor via the communication interface.

In step S504, the wireless signal received by the wireless communication module is parsed to obtain a parsing result.

Specifically, the first processor receives the wireless signals transmitted by the wireless communication module, and the received wireless signals vary with the different wireless communication modules. The first processor parses the wireless signals, and the different wireless signals are parsed to obtain different parsing results. The parsing results may be an identification of the transmitting device, an identification of the target device, and the specific content.

[symbol] ccording to an embodiment, the first processor transmits the parsing results to the wireless communication module.

In step S506, the wireless signal is enhanced by the wireless communication module.

nded cically, the wireless communication module can directly enhance the signal according to the type of the wireless signal, e.g., a WIFI module can enhance the WIFI wireless signal.

According to an embodiment, the wireless communication module receives the parsing results transmitted by the first processor according to the type of the wireless signal, such as a Z-WAVE module and a 433/868/915 MHz transceiver module, and the wireless signal is enhanced in different ways according to the different parsing results.

According to an embodiment, when the wireless communication module receiving the wireless signal is the WIFI module, the WIFI module relays and amplifies the received wireless signal and then transmits the received wireless signal via a modulation-demodulation method.

According to an embodiment, when the wireless communication module receiving the wireless signal is the Z-WAVE module, the Z-WAVE module receives a node identification of a target Z-WAVE device obtained by parsing the wireless signal via the first processor, and transmits the received wireless signal to the target Z-WAVE device via the modulation-demodulation method according to the node identification.

According to an embodiment, when the wireless communication module receiving the wireless signal is the 433/868/915 MHz transceiver module, the 433/868/915 MHz transceiver module monitors and receives a wireless signal of 433/868/915 MHz band, and transmits the wireless signal to the first processor, and determines the number of times of forwarding the wireless signal according to an identification of a transmitting device and information content obtained after the first processor parses the wireless signal using a customized communication protocol, and forwards the wireless signal according to the number of times of forwarding the wireless signal.

According to an embodiment, after the wireless signal is enhanced by the wireless communication module, the method further includes detecting signal strength of the received wireless signal, and determining a wireless signal strength level of a current wireless signal area according to the signal strength of the wireless signal, and then transmitting the wireless signal strength level of the wireless signal area to the first processor.

According to an embodiment, after the wireless signal is enhanced by the wireless communication module, the method further includes: when the first processor is coupled to the mobile device via the communication interface, transmitting the parsing result and the wireless signal strength level to the mobile device via the communication interface, such that the mobile device can move according to the parsing result and the wireless signal strength level. It can be flexibally achieved to enhance the wireless signal strength in an area where the wireless signal is weak, so as to allow the user to access wireless devices better and easier no matter where they are in the area.

According to the aforementioned embodiments, corresponding wireless signal is received by different wireless communication modules, such as the WIFI module, the Z-WAVE module and the 433/868/915 MHz transceiver module, and the wireless signal is transmitted to the server via the communication interface. The server parses the wireless signal and transmits the wireless signal to the corresponding wireless communication module. The wireless communication module transmits the wireless signal according to the parsing result, and achieves enhancement of multiple wireless signals. Therefore the device for receiving the wireless signal can receive the wireless signal transmitted by the transmitting device more easily.

According to an embodiment, a wireless signal enhancement system includes:

at least two wireless communication modules of different types used to receive corresponding wireless signal and transmit the wireless signal to a first processor; and

the first processor coupled to the wireless communication module and used to receive and parse the wireless signal transmitted by the wireless communication module to obtain a parsing result;

the wireless communication module receiving the wireless signal is further used to enhance the wireless signal; and

a mobile device coupled to the first processor, the mobile device is used to receive the parsing result and a wireless signal strength level obtained by parsing the wireless signal via the first processor, and the mobile device moves according to the parsing result and the wireless signal strength level.

According to an embodiment, the wireless communication module includes:

a WIFI module coupled to the first processor, the WIFI module is set as a wireless relay mode and is configured to relay and amplify the received wireless signal and then transmit the received wireless signal via a modulation-demodulation method.

According to an embodiment, the wireless communication module includes:

a Z-WAVE module coupled to the first processor, the Z-WAVE module is set as a control device and is used to receive a node identification of a target Z-WAVE device obtained by parsing the wireless signal via the first processor. The Z-WAVE module is used to transmit the received wireless signal to a target Z-WAVE device via the modulation-demodulation method according to the node identification.

According to an embodiment, the wireless communication module includes:

a 433/868/915 MHz transceiver module coupled to the first processor, the 433/868/915 MHz transceiver module is set as a receiving mode to monitor, and is used to receive a wireless signal of 433/868/915 MHz band and transmit the wireless signal to the first processor. The 433/868/915 MHz transceiver module is used to determine the number of times of forwarding the wireless signal according to an identification of a transmitting device and information content obtained after the first processor parses the wireless signal using a customized communication protocol. The 433/868/915 MHz transceiver module is used to forward the wireless signal according to the number of times of forwarding the wireless signal.

According to an embodiment, the wireless communication module is further used to detect signal strength of the received wireless signal and determine a wireless signal strength level of a current wireless signal area according to the signal strength of the wireless signal. The wireless communication module is further used to transmit the wireless signal strength level of the wireless signal area to the first processor.

According to an embodiment, the wireless signal enhancement system further includes:

a communication interface coupled to the first processor; and

the communication interface can be further coupled to a mobile device and is used to transmit data of the first processor to the mobile device, such that the mobile device performs data exchange with the first processor via the communication interface.

According to an embodiment, the mobile device includes:

a second processor coupled to the communication interface, the second processor is used to receive the parsing result and the wireless signal strength level transmitted by the first processor. The second processor is used to transmit a moving instruction to a control module according to the parsing result and the wireless signal strength level;

the control module configured to receive the moving instruction and control the mobile device to move according to the received moving instruction;

a power supply module configured to power the wireless signal enhancement system; and

the second processor is coupled to the control module and the power supply module, respectively.

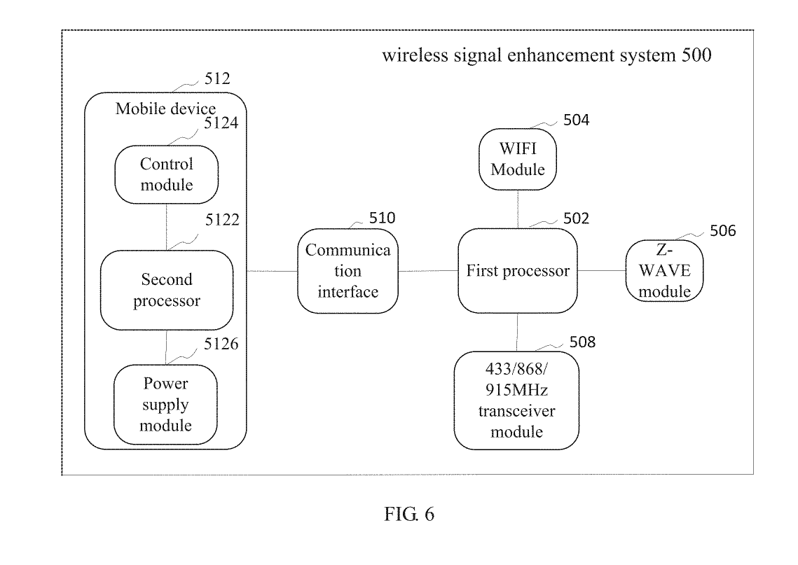

Referring to FIG. 6, according to an embodiment, a wireless signal enhancement device 500 is provided, which includes a first processor 502, a WIFI module 504, a Z-WAVE module 506, a 433/868/915 MHz transceiver module 510, and a mobile device 512. The mobile device 512 includes a second processor 5122, a control module 5124, and a power supply module 5126.

The WIFI module 504 is coupled to the first processor 502 via a communication interface. The communication interface can be a USB interface, a SDIO interface, or an IIC interface. The WIFI module 504 is set as a wireless relay mode, which takes advantage of a function of wireless relay of an AP to relay the wireless signal from one relay point to a next relay point to form a new wireless coverage area. Therefore the relay mode of multiple wireless relay coverage points is formed, thereby achieving the purpose of extending the coverage range of the wireless network. The WIFI module 504 is equivalent to the relay point, which can relay and amplify the received wireless signal and then transmit the received wireless signal via the modulation-demodulation method to form wireless signal coverage.

The Z-WAVE module 506 is coupled to the first processor 502 via the communication interface. The communication interface may be the USB interface, the SDIO interface, or the IIC interface. The Z-WAVE module can receive and transmit a wireless signal of a Z-WAVE protocol via a FSK modulation-demodulation method. The Z-WAVE module 506 is set as a control device. Specifically, there are two fundamental types of devices in the Z-WAVE protocol, a controller device and a slave device. The controller device can transmit a control instruction to other nodes, and the slave device can respond to the corresponding control instruction. The Z-WAVE module 506 receives the node identification of the target Z-WAVE device obtained by parsing the wireless signal via the first processor 502, and transmits the received Z-WAVE wireless signal to the target Z-WAVE device via the FSK modulation-demodulation method according to the node identification. The 433/868/915 MHz transceiver module 508 is coupled to the first processor 502 via the communication interface. The communication interface may be the USB interface, the SDIO interface, or the IIC interface. The 433/868/915 MHz transceiver module 508 is set as the receiving mode and permanently receives the 433/868/915 MHz band and monitors the wireless signal of the 433/868/915 MHz band. A monitoring band of the 433/868/915 MHz transceiver module 508 should be the same as a receiving band of the 433/868/915 MHz communication device requiring to forward signal. The 433/868/915 MHz transceiver module 508 communicates with the 433/868/915 MHz communication device requiring to forward signal using the same communication protocol, i.e., a customized communication protocol. The 433/868/915 MHz transceiver module 508 receives the wireless signal and transmits the wireless signal to the first processor 502. The first processor 502 parses the wireless signal according to the customized communication protocol to obtain the identification of the transmitting device and the information content, so as to determine the number of times of forwarding the wireless signal. Such that the first processor 502 forwards the wireless signal according to the number of times of forwarding the wireless signal, and performs different processes to the different devices and the different information contents. For example, the process is performed according to an importance of the information content. If the information contents are only data content regularly reported by the transmitting terminal, for example, data information such as temperature and humidity which is forwarded only once; as for warning information such as a smoke sensor and a combustible gas sensor, which should be forwarded multiple times, usually three to five times, so as to ensure that the data package of the content will not be lost.

The communication interface 510 is coupled to the first processor 502. The communication interface 510 can be further coupled to a mobile device 512 and is used to transmit data of the first processor 502 to the mobile device 512, such that the mobile device 512 performs data exchange with the first processor 502 via the communication interface.

The communication interface 510 can be the USB interface, the SDIO interface, or the IIC interface.

A second processor 5122 of the mobile device 512 receives the parsing result and the wireless signal strength level transmitted by the first processor 502, and the second processor 5122 is used to transmit a moving instruction to a control module according to the parsing result and the wireless signal strength level. The parsing result can be a node identification of a target Z-WAVE device parsed and obtained by the first processor 502 in the Z-WAVE module. The parsing result can be an identification and content of a transmitting device obtained from the 433/868/915 MHz transceiver module 508. The wireless signal strength level may be strength level of the WIFI wireless signal, strength level of the Z-WAVE wireless signal, or strength level of the wireless signal of the 433/868/915 MHz band. The control component 5124 receives the moving instruction and moves according to the moving instruction. For example, if alarm information obtained by parsing the wireless signal of the 433/868/915 MHz band is received, the control module 5124 can move to an alarm location and enhance the wireless signal at the alarm location. The power supply module 5126 is coupled to the second processor 5122 for powering the wireless signal enhancement system 500, such that the wireless signal enhancement system can operate normally.

According to an embodiment, a video device is mounted on the mobile device 512, and the control module 5124 can move to the alarm location to record.

According to the aforementioned embodiments, the wireless signal enhancement system transmits the parsing result and the wireless signal strength level parsed and obtained by the first processor to the mobile device. Such that the problem that the conventional wireless signal enhancement device can only enhance a single wireless signal in a fixed location can be solved, which makes the wireless signal enhancement system more suitable for enhancing the wireless signal in different situations, thereby facilitating the people to use the wireless signal.

A person skilled in the art should understand that the processes of the methods in the above embodiments can be, in full or in part, implemented by computer programs instructing underlying hardware. The programs can be stored in a computer-readable storage medium and executed by at least one processor in the computer operating system. The program can include the processes in the embodiments of the various methods when it is being executed. The storage medium can be a disk, a CD, a Read-Only Memory (ROM), or a Random Access Memory (RAM) and so on.

Although the respective embodiments have been described one by one, it shall be appreciated that the respective embodiments will not be isolated. Those skilled in the art can apparently appreciate upon reading the disclosure of this application that the respective technical features involved in the respective embodiments can be merged arbitrarily between the respective embodiments as long as they have no collision with each other. Of course, the respective technical features mentioned in the same embodiment can also be merged arbitrarily as long as they have no collision with each other.

Although the invention is illustrated and described herein with reference to specific embodiments, the invention is not intended to be limited to the details shown. It should be noted that any variation or replacement readily figured out by a person skilled in the art within the technical scope disclosed in the present invention shall all fall within the protection scope of the present invention. Therefore, the protection scope of the present invention shall be subject to the protection scope of the appended claims.

What is claimed is:

1. A wireless signal enhancement device, comprising:
at least two wireless communication modules of different types configured to receive corresponding wireless signal and transmit the wireless signal to a first processor; and
the first processor coupled to the wireless communication module and configured to receive and parse the wireless signal transmitted by the wireless communication module to obtain a parsing result;
wherein the wireless communication module receiving the wireless signal is further configured to enhance the wireless signal.

2. The device of claim 1, wherein the wireless communication module comprises a wireless fidelity (WIFI) module coupled to the first processor, the WIFI module is set as a wireless relay mode and is configured to relay and amplify the received wireless signal and then transmit the received wireless signal via a modulation-demodulation method.

3. The device of claim 1, wherein the wireless communication module comprises a Z-WAVE module coupled to the first processor, the Z-WAVE module is set as a control device and is configured to receive a node identification of a target Z-WAVE device obtained by parsing the wireless signal via the first processor, and to transmit the received wireless signal to the target Z-WAVE device via a modulation-demodulation method according to the node identification.

4. The device of claim 1, wherein the wireless communication module comprises a 433/868/915 MHz transceiver module coupled to the first processor, the 433/868/915 MHz transceiver module is set as a receiving mode and is configured to monitor and receive a wireless signal of 433/868/915 MHz band, and the 433/868/915 MHz transceiver module is configured to transmit the wireless signal to the first processor and determine the number of times of forwarding the wireless signal according to an identification of a transmitting device and information content obtained after the first processor parses the wireless signal using a customized communication protocol, and to forward the wireless signal according to the number of times of forwarding the wireless signal.

5. The device of claim 1, wherein the wireless communication module is further configured to detect signal strength of the received wireless signal and determine a wireless signal strength level of a current wireless signal area according to the signal strength of the wireless signal, and the wireless communication module is further configured to transmit the wireless signal strength level of the wireless signal area to the first processor.

6. The device of claim 5, further comprising:
a communication interface coupled to the first processor;
wherein the communication interface is further coupled to a mobile device and is configured to transmit data of the first processor to the mobile device, such that the mobile device performs data exchange with the first processor via the communication interface.

7. The device of claim 6, wherein the communication interface is also coupled to a power supply of the mobile device to power the device.

8. The device of claim 6, wherein the first processor is configured to transmit the parsing result and the wireless signal strength level to the mobile device via the communication interface, such that the mobile device moves according to the parsing result and the wireless signal strength level.

9. A wireless signal enhancement method, comprising:
receiving, by at least two wireless communication modules of different types, corresponding wireless signal;
parsing the wireless signal received by the wireless communication module to obtain a parsing result; and
enhancing, by the wireless communication modules, the wireless signal.

10. The method of claim 9, wherein the enhancing the wireless signal by the wireless communication module comprises:
relaying and amplifying, by a WIFI module, the received wireless signal, and transmitting the received wireless signal via a modulation-demodulation method, when the wireless communication module receiving the wireless signal is the WIFI module;
receiving, by a Z-WAVE module, a node identification of a target Z-WAVE device obtained by parsing the wireless signal via the first processor, and transmitting the received wireless to the target Z-WAVE device via the modulation-demodulation method according to the node identification, when the wireless communication module receiving the wireless signal is the Z-WAVE module; and
monitoring and receiving, by a 433/868/915 MHz transceiver module, a wireless signal of 433/868/915 MHz band, transmitting the wireless signal to the first processor, and determining the number of times of forwarding the wireless signal according to an identification of a transmitting device and information content obtained after the first processor parses the wireless signal using a customized communication protocol, and forwarding the wireless signal according to the number of times of forwarding the wireless signal, when the wireless communication module receiving the wireless signal is the 433/868/915 MHz transceiver module.

11. The method of claim 9, wherein after enhancing the wireless signal by the wireless communication module, the method further comprises:
detecting signal strength of the received wireless signal, determining a wireless signal strength level of a current wireless signal area according to the signal strength of the wireless signal, and transmitting the wireless signal strength level of the wireless signal area to the first processor.

12. The method of claim 9, wherein after enhancing the wireless signal by the wireless communication module, the method comprises:
transmitting, via a communication interface, the parsing result and the wireless signal strength level to a mobile device, when the first processor is coupled to the mobile device via the communication interface, such that the mobile device moves according to the parsing result and the wireless signal strength level.

13. A wireless signal enhancement system, comprising:
at least two wireless communication modules of different types configured to receive corresponding wireless signal and transmit the wireless signal to a first processor;
the first processor coupled to the wireless communication module and configured to receive and parse the wireless signal transmitted by the wireless communication module to obtain a parsing result; wherein the wireless communication module receiving the wireless signal is further configured to enhance the wireless signal; and
a mobile device coupled to the first processor, the mobile device being configured to receive the parsing result and a wireless signal strength level obtained by parsing the wireless signal by the first processor, and the mobile device moving according to the parsing result and the wireless signal strength level.

14. The system of claim 13, wherein the wireless communication module comprises a WIFI module coupled to the first processor, the WIFI module is set as a wireless relay mode and is configured to relay and amplify the received wireless signal and then transmit the received wireless signal via a modulation-demodulation method.

15. The system of claim 13, wherein the wireless communication module comprises a Z-WAVE module coupled to the first processor, the Z-WAVE module is set as a control device and is configured to receive a node identification of a target Z-WAVE device obtained by parsing the wireless signal via the first processor, and the Z-WAVE module is configured to transmit the received wireless signal to the target Z-WAVE device via a modulation-demodulation method according to the node identification.

16. The system of claim 13, wherein the wireless communication module comprises a 433/868/915 MHz transceiver module coupled to the first processor, the 433/868/915 MHz transceiver module is set as a receiving mode to monitor and receive a wireless signal of 433/868/915 MHz band, and the 433/868/915 MHz transceiver module is configured to transmit the wireless signal to the first processor and determine the number of times of forwarding the wireless signal according to an identification of a transmitting device and information content obtained after the first processor parses the wireless signal using a customized communication protocol, and the 433/868/915 MHz transceiver module is configured to forward the wireless signal according to the number of times of forwarding the wireless signal.

17. The system of claim 13, wherein the wireless communication module is further configured to detect signal strength of the received wireless signal and determine a wireless signal strength level of a current wireless signal area according to the signal strength of the wireless signal, and the wireless communication module is further configured to transmit the wireless signal strength level of the wireless signal area to the first processor.

18. The system of claim 13, further comprising:
a communication interface coupled to the first processor;
wherein the communication interface is further coupled to a mobile device and is configured to transmit data of the first processor to the mobile device, such that the mobile device performs data exchange with the first processor via the communication interface.

19. The system of claim 13, wherein the mobile device comprises:
a second processor coupled to the communication interface, the second processor is configured to receive the parsing result and the wireless signal strength level and is configured to transmit a moving instruction to a control module according to the parsing result and the wireless signal strength level;
the control module configured to receive the moving instruction and control the mobile device to move according to the received moving instruction;
a power supply module configured to power the wireless signal enhancement system; and
wherein the second processor is coupled to the control module and the power supply module, respectively.

20. At least one non-transitory computer-readable medium comprising computer executable instructions, which, when executed by at least one processor cause the at least one processor to perform steps comprising:
receiving, by at least two wireless communication modules of different types, corresponding wireless signal;
parsing the wireless signal received by the wireless communication modules to obtain a parsing result; and
enhancing, by the wireless communication modules, the wireless signal.
